(19) United States
(12) Patent Application Publication
(10) Pub. No.: US 2021/0264356 A1
(43) Pub. Date: Aug. 26, 2021

(54) SYSTEMS AND METHODS FOR PAIRING EXECUTORS WITH ORDERS

(71) Applicant: Michele Gryniewicz, San Diego, CA (US)

(72) Inventor: Michele Gryniewicz, San Diego, CA (US)

(21) Appl. No.: 17/185,107

(22) Filed: Feb. 25, 2021

Related U.S. Application Data
(60) Provisional application No. 62/981,292, filed on Feb. 25, 2020.

(51) Int. Cl. G06Q 10/08; G06Q 30/06

(52) U.S. Cl. CPC G06Q 10/0834; G06Q 30/0635

(57) ABSTRACT

Systems, methods, and devices may match customers with executors to fulfill orders. An order request may be received from a second computing device that is authenticated to the application using a first user profile. The order request may include an item list having an item and a price associated with the item. A user address and a payment account of the first user profile may be associated with the order request. A second user profile may be selected for pairing with the first user profile. The order request may be transmitted to a third computing device in response to the third computing device being authenticated to the application using the second user profile. The first user profile may be paired to the second user profile in response to an input from the third device approving at least one of the order request and the first user profile.

### CROSS REFERENCE TO RELATED APPLICATIONS

This application claims priority to U.S. Provisional Application No. 62/981,292, filed on Feb. 25, 2020, which is incorporated by reference in its entirety for any purpose.

### FIELD

The present disclosure relates to systems and methods for connecting runners and orders on a distributed network.

### BACKGROUND

Modern society relies heavily on delivery, mobility, and social connectivity services. Ride-sharing arrangements are now ubiquitous thanks to offerings from UBER or LYFT, delivery services touch most parts of life thanks to services offered by AMAZON and POSTMATES, and people are connected every day through neighborhood and dating apps. Still, none of these modern advances take into consideration the plight of a mother.

Many people feel uncomfortable with seemingly un-vetted strangers visiting their house, driving them, or handling their food. Moms are a good example of a group of people facing unique challenges in looking out for their children in this age of delivery and online services. For example, a mother may not trust just anyone to pick up baby food or otherwise assist with the needs of her young child. Many times, for example, a ride-share driver may pick up a mother but make her uncomfortable with perceived unsafe driving endangering her child. Similarly, a mother may feel uncomfortable with an un-vetted stranger showing up at her door or handling her child's formula.

While mothers are one obvious example, these problems extend to all walks of life. People constantly fear damaged goods, porch pirates, poorly selected food, or other shortcomings with crowd-sourced services and goods. With a pandemic threatening peoples health and livelihoods, these uncertainties about strangers are amplified.

### SUMMARY

Systems, methods, and devices (collectively, the “System”) of the present disclosure may match customers with executors to fulfill orders. The System may receive an order request from a second computing device that is authenticated to the application using a first user profile. The order request may include an item list having an item and a price associated with the item. The System may associate a user address and a payment account of the first user profile with the order request, and select a second user profile for pairing with the first user profile. The System may transmit the order request to a third computing device in response to the third computing device being authenticated to the application using the second user profile. The System may pair the first user profile to the second user profile in response to an input from the third device approving at least one of the order request and the first user profile. The order request may be transmitted to the third computing device for execution.

In various embodiments, the System may receive an input on the second computing device to select the second user profile from a friend list presented on the second computing device. The System may receive at least one of a receipt image, a final cost, and a final quantity in response to purchasing the item. The first computing device may transmit to the second computing device at least one of the receipt image, the final cost, and the final quantity. The second computing device may receive a communication from the third computing device to set a time for delivery. Payment may be remitted through the payment service to the executor logged into the second user profile in response to the executor fulfilling the order request. The System may receive a communication from the second computing device to assess availability of the executor of the second user profile authenticated on the third computing device. The second computing device may generate the order request in response to the third computing device confirming availability of the executor of the second user profile to fulfil the order request.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 illustrates a computer-based system for matching order executors with ordering customers based on selectable criteria, in accordance with various embodiments;

FIG. 2 illustrates a computer-based system for matching order executors with ordering customers based on selectable criteria in furtherance of a transaction, in accordance with various embodiments;

FIG. 3 illustrates a process for pairing an executor with a customer previously connected on a friends list, in accordance with various embodiments;

FIGS. 4A and 4B illustrates a process for a customer to generate an order for fulfillment by an executor previously connected on a friends list or otherwise based on selectable criteria, in accordance with various embodiments;

FIG. 5 illustrates a process for pairing a customer with an executor in response to selectable criteria, in accordance with various embodiments; and

FIGS. 6A and 6B illustrate a process for saving a receipt generated by an executor in association with a transaction on behalf of a customer, in accordance with various embodiments.

Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

### DETAILED DESCRIPTION

The detailed description of exemplary embodiments herein refers to the accompanying drawings, which show exemplary embodiments by way of illustration. While these exemplary embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected or the like may include permanent, removable, temporary, partial, full and/or any other possible attachment option. Additionally, any reference to without contact (or similar phrases) may also include reduced contact or minimal contact.

As used herein, the term “pop” refers to an order or request for goods or services. The term “Mommr” refers to a customer or an individual placing an order for goods or services (e.g., creating a pop) using the computer-based systems described herein. The term “Wrunnr” may refer to an executor 106 or other individual fulfilling an order or a pop using the computer-based systems described herein.

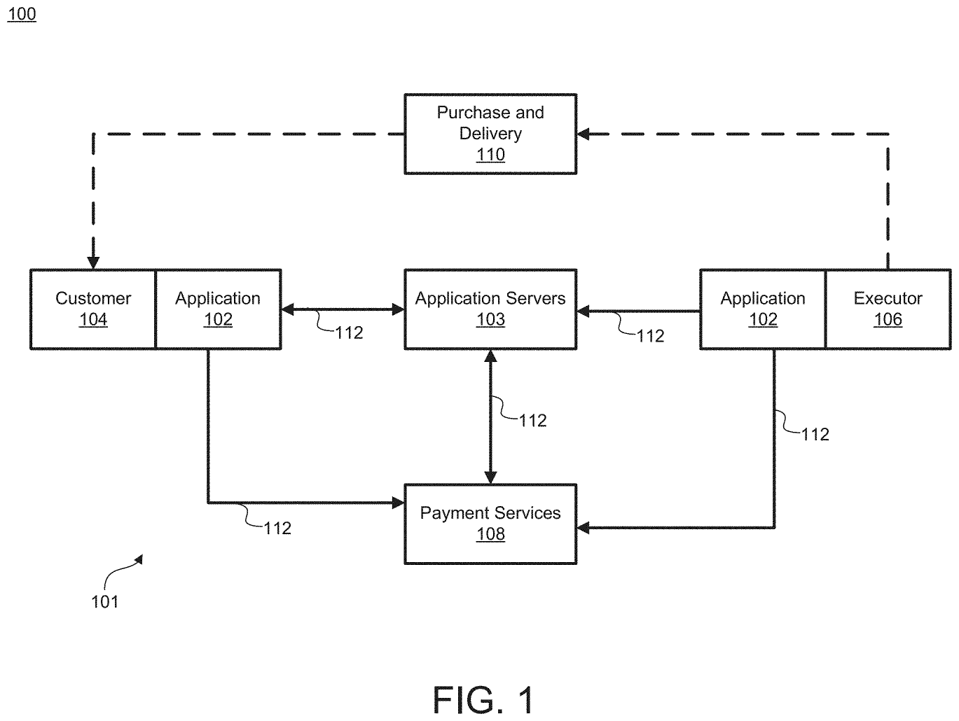

Referring now to FIG. 1, architecture 100 for a computer-based system 101 is shown, in accordance with various embodiments. The system 101 may comprise a computing and networking environment suitable for implementing aspects of the present disclosure. In general, the system 101 includes multiple computing devices represented in FIG. 1 by customer 104 running application 102, executor 106 running application 102, application servers 103 supporting application 102, and/or payment services 108 in communication with application 102.

In various embodiments, each computing device may comprise a processor in communication with a non-transitory memory capable of storing and executing instructions. Suitable computing devices may include, for example, a server, controller, personal computer, terminal, workstation, portable computer, mobile device, smartphone, tablet, mainframe, virtualized server, cloud service provider, Internet of Things (IoT) device, other suitable computing devices either operating alone or in concert. System 101 may include a plurality of computing devices connected through a computer network 112, which may include the Internet, an intranet, a virtual private network (VPN), a local area network (LAN), or the like. Cloud (not shown) hardware and/or software system may be implemented to execute one or more components of the system 101.

In various embodiments, computing device may comprise computing hardware capable of executing software instructions through at least one processing unit. Computing device may further implement functionality associated with placing and fulfilling orders including giving executors 106 and/or customers 104 control over the other party. Components and functionality of computer-based system 101 are described in greater detail below.

Architecture 100 may comprise application 102 in communication with customer 104 and executor 106 both operating through computing devices running application 102 and in communication with each other. Application 102 may have selectable operating modes wherein application 102 interacts with customer 104 and/or executor 106 in response to a switch, button, or other setting made in application 102 running on their respective computing device. In that regard, a user may select his or her role with computer-based system 101 by setting their application 102 into a mode for either customer 104 or executor 106.

In various embodiments, application 102 operating in customer 104 mode may present and receive responses relating to the privacy policy, customer profile, delivery address, home address, location, contact information, or other information and confirmations. Application 102 may also present customer 104 with a smart item list, list of potential executors 106 to select from, chat orders, price negotiations, status reports, payment requests, or other information. Application 102 operating in customer 104 mode may accept from customer 104 order details, friend list changes, selection of an executor 106, payment agreements, or other information suitable for executing a delivery order.

In various embodiments, application 102 operating in executor 106 mode may present executor 106 and receive responses relating to the privacy policy, profile information, car information, home address, location, or other information and confirmations. Application 102 may accept from executor 106 order details, friend list changes, pairing approval, price negotiation, receipt images, or other information suitable for executing a mobile order. Application 102 may prompt executor 106 for confirmation request, order details, chat orders, price negotiation, requests for payment account information, or other information suitable for executing a purchase and delivery order.

In various embodiments, payment service 108 may be in communication with application 102, customer 104, and/or executor 106 over network 112. Payment servicer 108 may comprise a third-party service provider capable of processing payments via ACH, EBT, card transactions, online payment services, or other third-party payment providers. Customer 104 may create a payment account with the third-party payment service to complete payments, and executor 106 may register a payment account with payment service 108 to receive payment. Payment service 108 may establish the payment accounts with application 102 by sending tokens associated with accounts to application 102. Computer-based system 101 may charge customer 104 and/or remit payment to executor 106 in response to a fulfilled transaction.

In various embodiments, executor 106 may purchase goods requested by customer 104 through application 102 from a vendor at an agreed upon price. Executor 106 may upload a receipt of the purchase to application 102 for viewing by customer 104. Executor 106 may also deliver the goods to customer 104 after purchasing to complete the delivery. Executor 106 and/or customer 104 may elect whether to work with one another by approving a pairing or otherwise setting selection criteria in application 102.

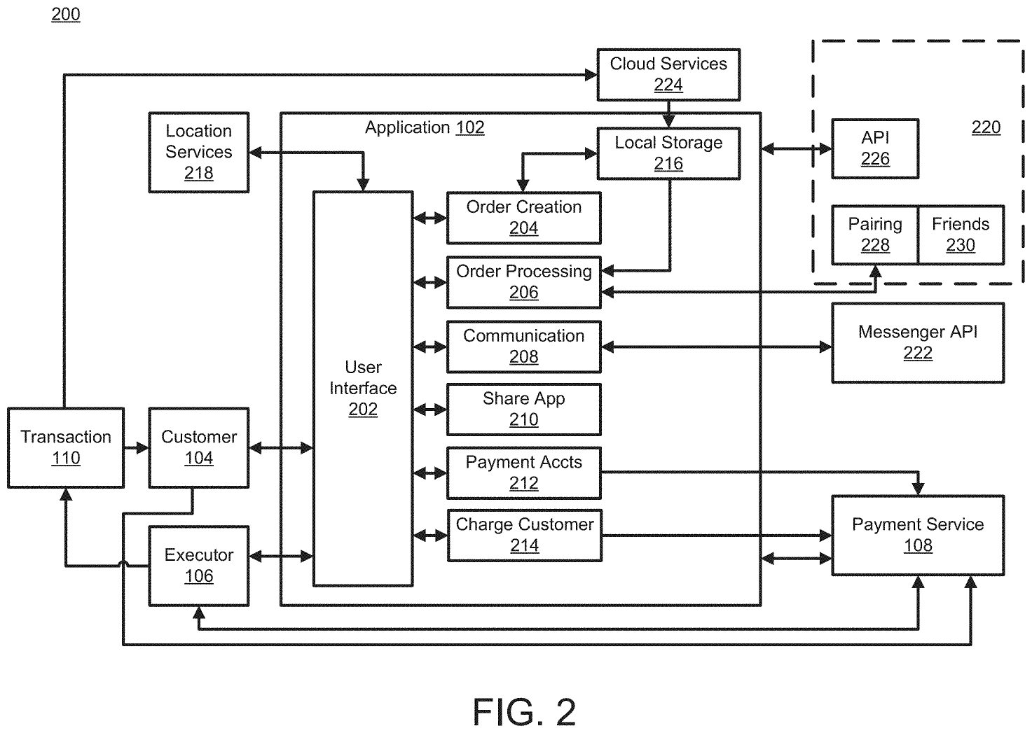

With reference to FIG. 2, an exemplary architecture 200 of computer-based system 101 is shown, in accordance with various embodiments. Architecture 100 and architecture 200 may make up part of the same computer-based system 101 suitable for executing the processes illustrated and described herein. In that regard, the processes and steps described herein may operate on a system comprising one of architecture 100 and architecture 200. Systems may also operate in support of the processes and steps herein in concert with or independent from architecture 100 and architecture 200 according to various embodiments.

In various embodiments, application 102 may run on one or more computing devices and may include one or more user interface 202. User interface 202 may facilitate item lists for purchase, pop creation requests 204, and friends list management through order processing 206. User interface 202 may also facilitate listing and selecting available executors 106 through order processing 206. User interface 202 may also facilitate confirmation request and status information through order processing 206. Messaging between customer 104 and executor 106 may also function through user interface 202 by way of customer-executor communication application 208.

In various embodiments, user interface 202 may facilitate friend requests using sharing application 210. Account creation requests and transaction account information may be processed and prepared through the payment account application 212. Payment agreements from customer 104 may be processed using the charge customer application 214. The charge customer application 214 and the payment account application 212 may be in electronic communication with payment services 108. Payment services 108 may be payment services hosted by a bank or third-party payment provider. Payment services 108 may interact with application 102 using one or more tokens associated with a transaction account maintained by customer 104 and/or executor 106. The token may at least partially authenticate customer 104 or executor 106 using application 102 with payment services.

In various embodiments, communication application 208 may communicate electronically over network 112 (of FIG. 1) with an instant messenger service using a messenger Application Programming Interface (API) 222. Order processing application 206 may be in electronic communication with backend services 220 hosted remote from the computing devices running application 102 for customer 104 and/or executor 106. Backend services 220 may support an API interface 226, pairing services 228 to match customers 104 with executors 106, and friend services 230 to facilitate a persistent connection between customers 104 and executors 106 who prefer to work with one another in the future. Backend services 220 may be hosted by a cloud service provider, by the entity supporting and developing application 102, or by any other entity capable of hosting web services and communicating electronically with computing devices running application 102.

In various embodiments, order creation application 204 and processing application 206 may communicate with local storage 216 to read, write, or execute files related to user profile information, address information, car information of executor 106, order details, item lists, or other information in support of application 102. Location services 218 running on a computing device may also operate in support of application 102 by updating the location of customer 104, the location of executor 106, and/or the location of a retailer likely to service an order. In that regard, location may be an input used to match customer 104 to an executor 106 based on proximity to one another, proximity to a retailer, or other location-based decisions.

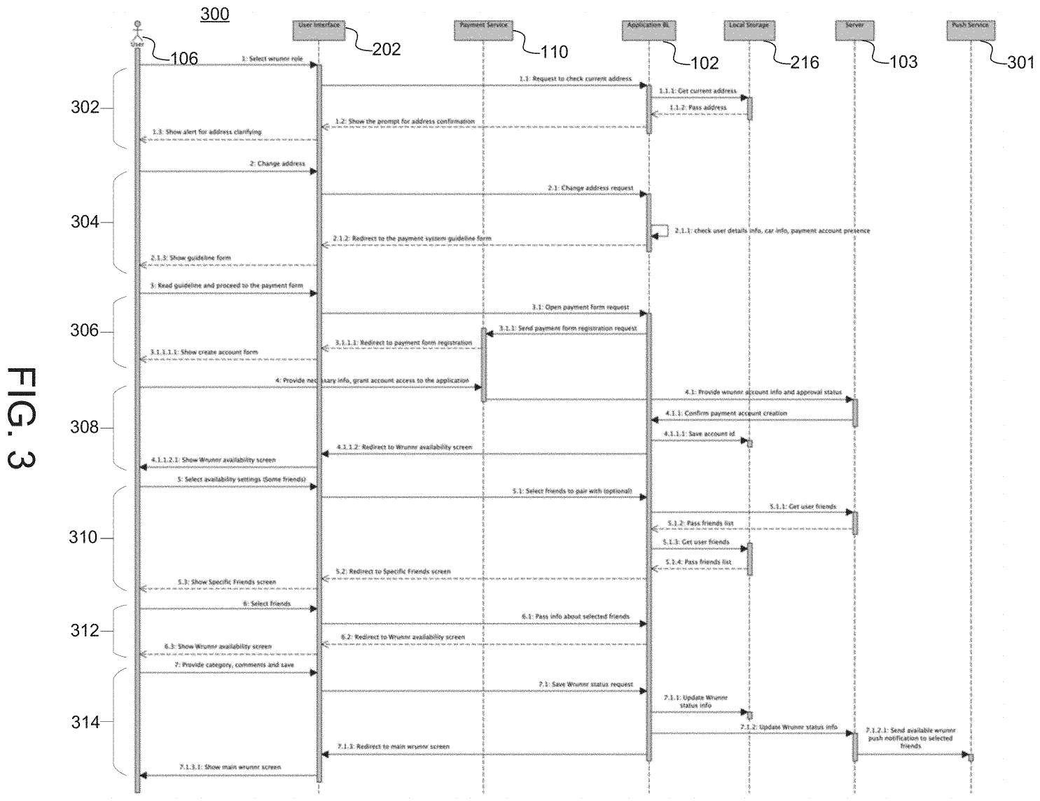

In FIGS. 3, 4A, 4B, 5, 6A, and 6B show examples of processes for execution with a computer-based system having architecture 100, architecture 200, and/or another suitable architecture. The processes are depicted with vertical bars beneath each entity or system component representing a timeline as it moves from the page numbers at the top of the page to the figure numbers bottom of the page. The process steps may be illustrated by horizontal arrows moving between the vertical bars beneath each entity. Steps of each illustrated process may thus be executed in order moving from the top of the page to the bottom of the page, though steps may also be executed in different orders with steps added and/or omitted in various embodiments. Steps from processes disclosed herein may also be integrated into other processes disclosed herein in any order.

With reference to FIG. 3, process 300 for pairing executor 106 with customer 104 is shown, in accordance with various embodiments. Process 300 may execute on a computer-based system 101 such as those depicted and described above in FIGS. 1 and 2. A user may activate an executor 106 role in application 102 by making a selection in user interface 202 (Step 302). Application 102 may check the location and/or address of executor 106 by prompting for address confirmation using user interface 202. Application 102 may also use location services such as a GPS integrated into a smartphone or other computing device in use by executor 106. The application 102 may access local storage 216 and/or cloud storage to retrieve address information associated with executor 106 including a last used address and/or an address history. User interface 202 may show an alert to executor 106 requesting confirmation or clarification of the executor's address and/or location.

In various embodiments, application 102 may update the executor's address in response to executor 106 requesting an address change in user interface 202 (Step 304). Application 102 may verify user details are present for executor 106 including, for example, car information, payment account information, and user information. Car information may include car make, car model, car year, car color, car license plate, or other information to aid in identification of a vehicle used by executor 106 to complete a transaction. Payment account information may include bank account and routing numbers, a user profile, charge card account number, charge card expiration, charge card security code, or other payment information to enable payment to executor 106 in response to a completed transaction. User information may include information describing executor 106 such as, for example, age, height, weight, eye color, hair color, or other information useable to visually identify executor 106. Application 102 may redirect user interface 202 to a payment system guideline form to update executor 106 and receive information as a user input.

In various embodiments, executor 106 submit or request a form of payment to establish and/or maintain a payment account (Step 306). Executor may review guidelines and request a fillable form for submitting information to application 102. Application 102 may send a payment form registration request to payment service 110 that supports payment accounts suitable for use with computer-based system 101. Payment service 110 may redirect executor 106 to a payment form registration form through user interface 202. User interface 202 may accept in the form registration information for executor 106.

In various embodiments, executor 106 may complete the payment form (Step 308) by inputting information into the form displayed on user interface 202. Executor 106 communicating with payment service 110 may submit information and grant account access to application 102. Payment service 110 transmit payment account information and authorization to application 102 by communicating with a server 103 over network 112. Application 102 may save an account identifier on local storage 116 and/or cloud or network storage. Application 102 may redirect user interface 202 to an executor availability screen to facilitate further interaction with executor 106.

In various embodiments, executor 106 may set their availability using user interface 202 (Step 310). Availability settings may include available to all, available to friends, available to some friends, available to a selected individual, or other suitable availability settings. Executor 106 may thus control which customers 104 (of FIGS. 1 and 2) can detect the availability executor 106 and/or elect to work with executor 106. Availability settings can expand or limit visibility of executor 106 to other users in application 102. Setting availability to all makes executor 106 visible across application 102. Setting availability to friends may limit visibility to any friend on the friend list for executor 106. Setting availability to some friends may limit visibility to selected friends from the friends list of executor 106. Executor 106 may also choose a single user availability setting to be available to only one other user on application 102.

In various embodiments, executor 106 may select friends for availability in limited availability modes (Step 312). For example, in response to setting availability to “some friends,” application 102 may retrieve the friends list for executor 106 from a remote server and/or from local storage. User interface 202 may present the friends list to executor 106 for selection of desired friends.

In various embodiments, executor 106 may select friends that executor 106 will be available to in application 102 in “some friends” or a “single friend” mode of operation. User interface 202 may pass selected friends into application 102. The selected friends may see executor 106 as available in application 102, and non-selected friends may not see executor 106 as available in application 102. Executor 106 may be presented an executor availability screen in user interface 202.

In various embodiments, executor 106 may enter availability information into user interface 202 (step 314). For example, executor 106 may enter a product category, comments, store availability, product availability, or other type of availability information signaling the type of transaction the executor 106 is available to complete. Application 102 may update the status of executor 106 for storage on local storage 216 or server 103. Server 103 may communicate with push service 301 to transmit a push notification to the selected friends. In that regard, executor 106 may contact friends and inform them of executor 106 status as available. User interface 202 may redirect to a home screen for executor 106. Process 300 depict setting up an account for executor 106, and a user may also select customer 104 role to cause computer-based system 101 to perform an analogous account creation and availability selection process.

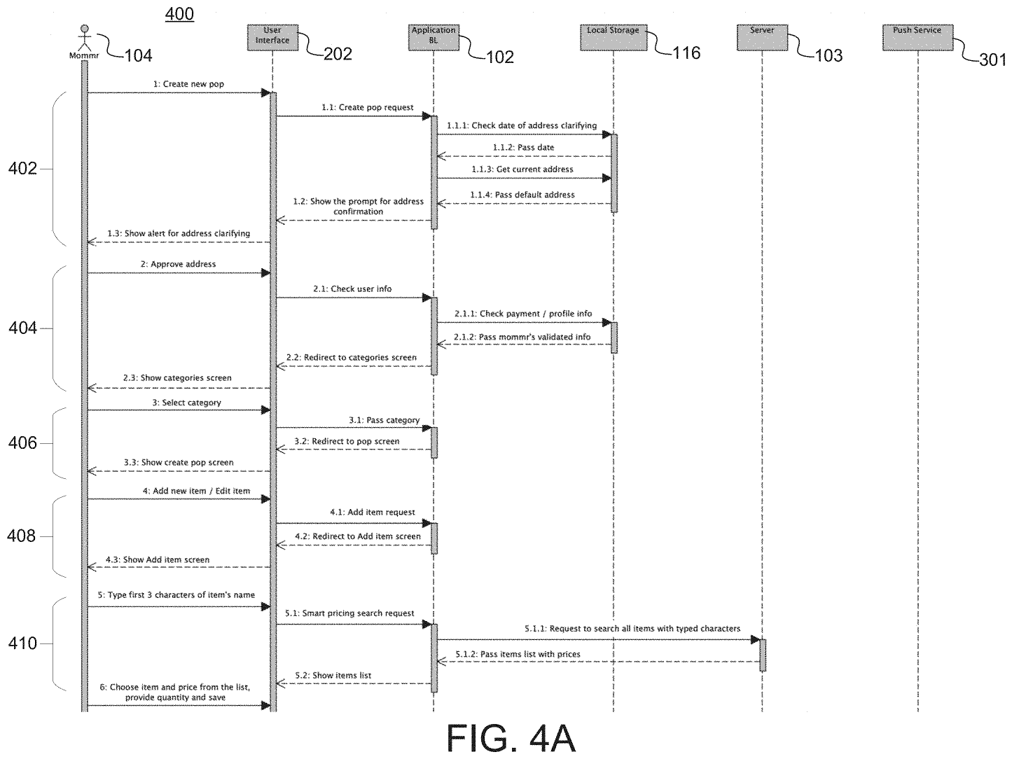

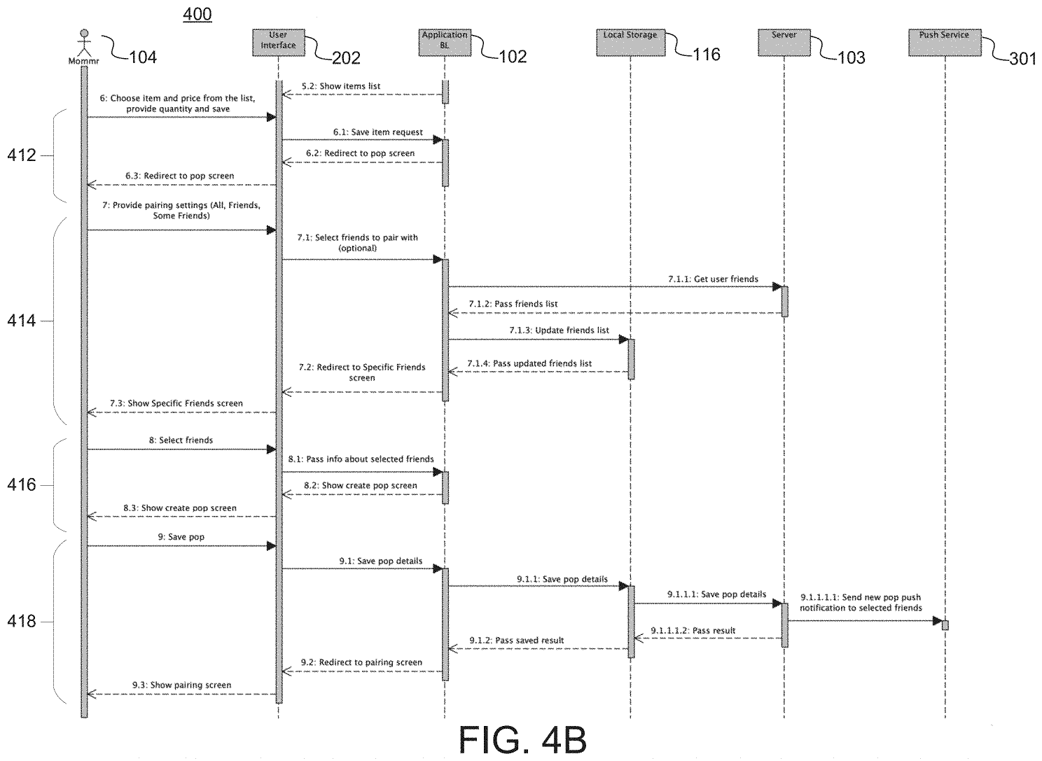

Referring now to FIGS. 4A and 4B, process 400 for creating an order is shown, in accordance with various embodiments. A user may be operating in customer 104 role by setting the role in user interface 202. Customer 104 may create a new order request in user interface 202 of application 102 (Step 402). Application 102 may retrieve address and/or location information for customer 104 and may prompt customer 104 for confirmation using user interface 202. Customer 104 may receive a request for verification or update of customer's desired delivery address.

In various embodiments, application 102 may confirm user information for customer 104 (Step 404). Application 102 may lookup payment account information and/or profile information for customer 104 in response to customer confirming a delivery address. Application 102 may redirect user interface 202 to a category selection screen in response to payment account information or user profile information passing a check or being verified by customer 104.

In various embodiments, user interface 202 may receive a category selection from customer 104 (Step 406). Category types may include categories of goods or services an executor 106 may provide. Application 102 may present an order creation screen on user interface 202 in response to receiving a category selection. Application 102 may receive an add item request from customer 104 in response to a selection made in user interface 202 (Step 408). The item may be an item in the selected category. User interface 202 may present numerous items in the selected category through user interface 202 to facilitate selection of items or services.

In various embodiments, items made available in application 102 to customer 104 may be searchable. For example, customer 104 may enter characters appearing in an item name or description into a smart pricing search request in user interface 202. Server 103 may receive the request and perform a search, returning a list of items with prices to application 102 for presentation in user interface 202. Other search parameters may include, for example, price, product category, product type, vendor name, vendor department, or other characteristic of products and services suitable for filtering. Other search techniques may be used such as, for example, hierarchical browsing, image lookup, or suggested products pages. User interface 202 may present customer 104 with selectable items (Step 410).

In various embodiments, user interface 202 may receive input from customer 104 selecting items, prices, and quantities using the list to identify items for purchase (Step 412). Application 102 may save the item request and/or redirect customer 104 to an order screen in response to receiving customer input selecting items. The order screen may facilitate pairing customer 104 with executor 106 based on input from the customer 104 and/or executor 106. In that regard, executor 106 may approve or decline working with customer 104. Similarly, customers 104 may approve or decline working with executor 106. Friends lists maintained by executor 106 and/or customer 104 may expedite pairing using application 102 by automatically approving pairs when executor 106 and customer 104 are on both friends lists. Friends lists may also expedite pairing by notifying executor 106 or customer 104 whether a proposed pairing is or is not with profile saved on their friends list.

In various embodiments, user interface 202 may receive selected pairing settings from customer 104 (Step 414). Pairing settings may include available to all, available to friends, available to some friends, available to a selected individual, or other suitable availability settings. Customer 104 may thus control which executors 106 (of FIGS. 1 and 2) can detect the availability customer 104 and/or elect to work with customer 104. Availability settings can expand or limit visibility of customer 104 to other users in application 102. Setting availability to all makes customer 104 visible across application 102. Setting availability to friends may limit visibility to any friend on the friend list for customer 104. Setting availability to some friends may limit visibility to selected friends from the friends list of customer 104. Customer 104 may also choose a single user availability setting to be available to only one other user on application 102.

In various embodiments, customer 104 may select desired friends in limited availability modes. For example, in response to setting availability to “some friends,” application 102 may retrieve the friends list for customer 104 from a remote server 103 and/or from local storage 116. User interface 202 may present the friends list to customer 104 for selection of desired friends.

In various embodiments, user interface 202 may receive as input selected friends from customer 104 approved for interaction in application 102 (Step 416) in “some friends” or a “single friend” mode of operation. User interface 202 may pass selected friends into application 102. The selected friends may see customer 104 as available in application 102, and non-selected friends may not see customer 104 as available in application 102. Customer 104 may be presented an order creation in user interface 202.

In various embodiments, user interface 202 may receive confirmation for an order (Step 418). Application 102 may save order details on local storage 116 and may transmit order details to server 103 to facilitate execution. Server 103 may send a new order notification to selected friends through push service 301. Selected friends may have an opportunity to pair with customer 104 in response to the push notification and/or in response to customer 104 selecting the friend. User interface 202 of customer 104 may be directed to a pairing screen in response to application 102 searching for an executor 106 selected from the friends list to accept the order. Customer 104 may also select an open mode of operation to allow any executor 106 nearby and available in application 102 to accept the order regardless of friends list status.

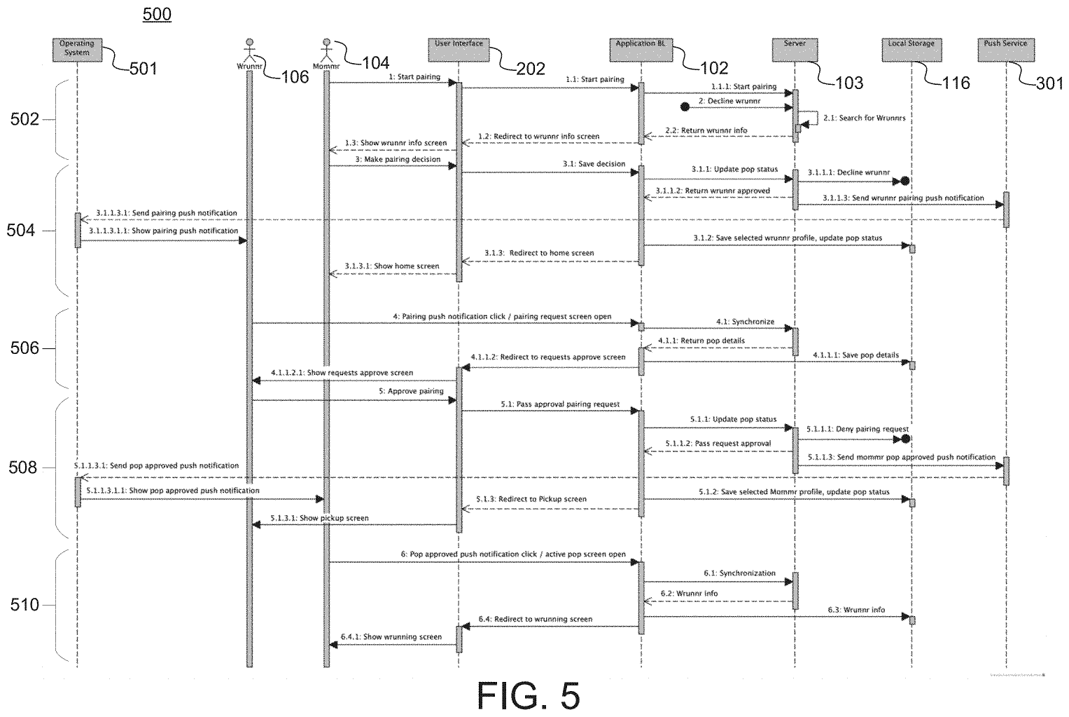

Referring now to FIG. 5, process 500 is shown for selectively pairing customer 104 with an executor 106, in accordance with various embodiments. User interface 202 of application 102 running on computing device of customer 104 may receive a pairing request from customer 104 (Step 502). Application 102 may contact server 103 to initiate pairing, and server 103 may search for executors 106 suitable for pairing with customer 104. Server may identify one or more potential executor 106 for pairing. Application 102 may present the potential executor 106 for pairing through user interface 202 to customer 104.

In various embodiments, application 102 may receive input from customer 104 approving or declining the proposed pairing with the identified executor 106 through user interface 202 (Step 504). The approve or decline input may be made in response to a prompt by user interface 202. The approve or decline decision may be made all or in part in response to selectable criteria set by customer 104 and/or executor 106. For example, customer 104 may set a start level threshold based on past reviews (e.g., no less than 4.5 out of 5 stars) or based on other measurable characteristics of potential executors 106. Executor 106 may set similar criteria for customer 104. Executor 106 may also set a premium markup percentage or monetary value for their services. More successful, professional, and/or better liked executors 106 may thus be compensated better than average executor 106. Customer 104 may approve any markup requests set by executor 106.

In various embodiments, server 103 of computer-based system 101 may search for executors 106 in response to customer 104 declining a pairing suggestion. Additional executors 106 may be presented through user interface 202 to customer 104 until customer 104 approves a proposed executor 106. Application 102 may record approved executor 106. Server 103 may request a push notification to approved executor 106 to prompt for executor to approve or decline pairing with customer 104.

In various embodiments, user interface 202 of application 102 may display a request approval screen on computing device of executor 106 (Step 506). Executor 106 may approve or decline pairing with customer 104 by entering a selection into user interface 202 (Step 508). Server 103 may search for other executors 106 suitable for pairing with customer 104 in response to proposed executor 106 declining a pairing.

In various embodiments, application 102 may notify customer 104 of the approved pairing (Step 510). Server 103 may send an approval push notification to customer 104 in response to proposed executor 106 approving the pairing. Application 102 running on an operating system 501 of the computing device of executor 106 may display a fulfillment screen through user interface 202 to direct acquisition of goods or services ordered by customer 104. Application 102 operating on computing device of customer 104 may display a pending screen through user interface 202 displaying order status information and/or information associated with the profile of executor 106.

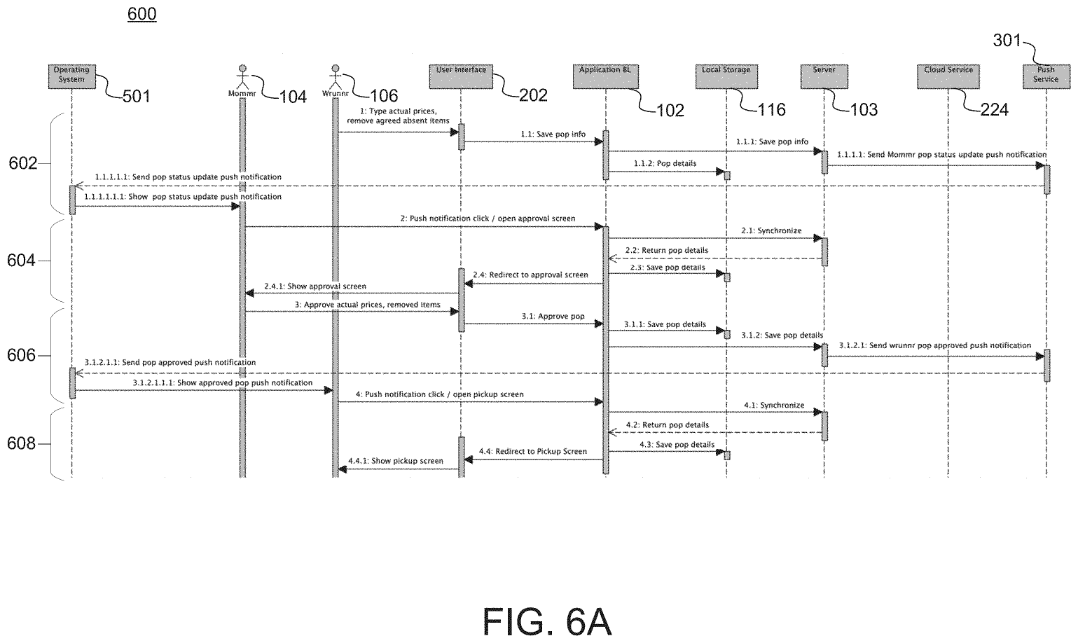

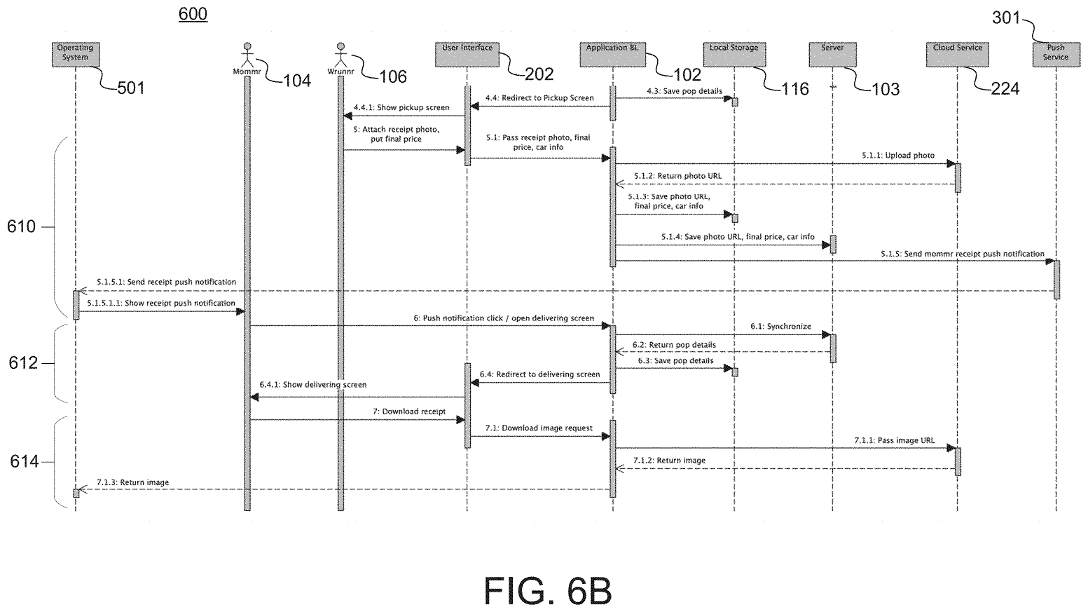

With reference to FIGS. 6A and 6B, process 600 is shown for fulfillment by executor 106 of an order made by customer 104, in accordance with various embodiments. User interface 202 running on a computing device may receive an updated item price from executor 106 in response to the actual price of goods available at a store being greater than or less than the price originally entered in an order (Step 602). Application 102 may write the updated order details to local storage 216. Application 102 may transmit uploaded order details to server 103. Server 103 may transmit a notification to customer 104. Operating system 501 running on a computing device of customer 104 may receive the notification and display through an operating system call and/or user interface 202.

In various embodiments, user interface 202 of application 102 may receive an input approving or declining a change in price and/or quantity of an item (Step 604). User interface 202 may display an approval screen for order changes. Application 102 may alter the quantity or pricing of items in an order in response to receiving input from customer 104 (Step 606). Application 102 may remove the item from the order in response to receiving customer 104 declining a price change. Application 102 may update the order to reflect a price change in response to customer 104 approving a price change. Application 102 may remove an item from an order in response to waiting for an approval or decline of a price change for a period greater than a timeout threshold.

In various embodiments, server 103 may send a notification to executor 106 in response to updating the price and/or quantity of an item in the order. User interface 202 may display a pickup screen to executor 106 (Step 608). Executor 106 may fulfill the order of customer 104 in accordance with the update to the price or quantity of an item. Fulfillment may comprise purchasing items from an order of customer 104 and delivering items to customer 104.

In various embodiments, user interface 202 may receive an image of a receipt uploaded from executor 106 for attachment to an order (Step 610). The image of the receipt may be captured and uploaded by a computing device of executor 106. For example, executor 106 may purchase the goods requested in an order by customer 104 and receive a receipt during checkout. Executor may then upload an image of the receipt to application 102 for association with the order. Executor may enter prices and quantity of items. Application 102 may also use text recognition to assess the quantity and cost of items. A uniform resource locator (URL) may be returned to application 102 linking to the image of the receipt stored on cloud service 224. The image of the receipt, the URL pricing, quantities may be stored in local storage 116, cloud service 224, and/or server 103 in association with executor 106 information such as car information. Application 102 may send a receipt notification to customer 104 in response to receiving the image of the receipt.

In various embodiments, application 102 may retrieve and display order details to customer 104 (Step 612). Application 102 may display a delivery screen on user interface 202 operating on computing device of customer 104. The delivery screen may include delivery information, order information, and information associated with profile of executor 106. Customer 104 may download and/or view the image of the receipt using the URL (Step 614).

In various embodiments, systems, methods, and devices of the present disclosure may pair customers 104 with executors 106 based on approval by each paired party. Customers and executors may thus control who they work with. Executors may send notification messages to customers on their friends lists to inform the customer that the executor is available to fulfill orders. Customers may also send notification messages to specific executors to inform the executor the customer requests assistance in a category or requesting an item. By controlling the parties to an order, the customers and executors can increase the comfort level and reduce anxiety sometimes associated with delivery services.

Benefits, other advantages, and solutions to problems have been described herein with regard to specific embodiments. Furthermore, the connecting lines shown in the various figures contained herein are intended to represent exemplary functional relationships and/or logical couplings between the various elements. It should be noted that many alternative or additional functional relationships or logical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosures is accordingly to be limited by nothing other than the appended claims and their legal equivalents, in which reference to an element in the singular is not intended to mean “one and only one” unless explicitly so stated, but rather “one or more.”

Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(1) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method for matching customers with executors to fulfill orders, comprising:
receiving, by an application running on a first computing device, an order request from a second computing device that is authenticated to the application using a first user profile, wherein the order request comprises an item list having an item and a price associated with the item;
associating, by the application running on the first computing device, a user address and a payment account of the first user profile with the order request;
selecting, by the first computing device and in response to an input on the second computing device, a second user profile for pairing with the first user profile;
transmitting, by the first computing device, the order request to a third computing device in response to the third computing device being authenticated to the application using the second user profile;
pairing, by the first computing device, the first user profile to the second user profile in response to an input from the third device approving at least one of the order request and the first user profile; and
transmitting, by the first computing device, the order request to the third computing device for execution.

2. The method of claim 1, wherein the input on the second computing device comprises a selection of the second user profile from a friend list presented on the second computing device authenticated with the first user profile.

3. The method of claim 1, further comprising receiving, by the first computing device and from the third computing device, at least one of a receipt image, a final cost, and a final quantity in response to purchasing the item.

4. The method of claim 3, further comprising transmitting, by the first computing device and to the second computing device, at least one of the receipt image, the final cost, and the final quantity.

5. The method of claim 1, further comprising receiving, by the second computing device, a communication from the third computing device to set a time for delivery.

6. The method of claim 1, further comprising remitting, by the first computing device and through a payment service, payment to the executor logged into the second user profile in response to the executor fulfilling the order request.

7. The method of claim 1, further comprising receiving, by the third computing device, a communication from the second computing device to assess availability of the executor of the second user profile authenticated on the third computing device.

8. The method of claim 7, further comprising generating, by the second computing device, the order request in response to the third computing device confirming availability of the executor of the second user profile to fulfil the order request.

9. A method for matching customers with executors to fulfill orders, comprising:
receiving, by an application running on a first computing device, an order request from a second computing device that is authenticated to the application using a first user profile, wherein the order request comprises an item list including a plurality of items;
associating, by the application running on the first computing device, a user address and a payment account of the first user profile with the order request;
selecting, by the first computing device and in response to an input on the second computing device, a second user profile for pairing with the first user profile;
pairing, by the first computing device, the first user profile to the second user profile in response to an input on a third computing device approving at least one of the order request and the first user profile, wherein the third computing device is authenticated to the application using the second user profile; and
transmitting, by the first computing device, the order request to the third computing device for execution.

10. The method of claim 9, wherein the input on the second computing device comprises a selection of the second user profile from a friend list presented on the second computing device authenticated with the first user profile.

11. The method of claim 9, further comprising receiving, by the first computing device and from the third computing device, at least one of a receipt image, a final cost, and a final quantity in response to purchasing the plurality of items.

12. The method of claim 11, further comprising transmitting, by the first computing device and to the second computing device, at least one of the receipt image, the final cost, and the final quantity.

13. The method of claim 9, further comprising receiving, by the second computing device, a communication from the third computing device to set a time for delivery.

14. The method of claim 9, further comprising receiving, by the third computing device, a communication from the second computing device to assess availability of the executor of the second user profile authenticated on the third computing device.

15. A computer-based system for matching customers with executors to fulfill orders, comprising:
a processor; and
a tangible, non-transitory memory configured to communicate with the processor, the tangible, non-transitory memory having instructions stored thereon that, in response to execution by the processor, cause the computer-based system to perform operations comprising:
receiving, by an application running on a first computing device, an order request from a second computing device that is authenticated to the application using a first user profile, wherein the order request comprises an item list including a plurality of items;
associating, by the application running on the first computing device, a user address and a payment account of the first user profile with the order request;
selecting, by the first computing device and in response to an input on the second computing device, a second user profile for pairing with the first user profile;
pairing, by the first computing device, the first user profile to the second user profile in response to an input on a third computing device approving at least one of the order request and the first user profile, wherein the third computing device is authenticated to the application using the second user profile; and
transmitting, by the first computing device, the order request to the third computing device for execution.

16. The computer-based system of claim 15, wherein the input on the second computing device comprises a selection of the second user profile from a friend list presented on the second computing device authenticated with the first user profile.

17. The computer-based system of claim 15, wherein the operations further comprise receiving, by the first computing device and from the third computing device, at least one of a receipt image, a final cost, and a final quantity in response to purchasing the plurality of items.

18. The computer-based system of claim 17, wherein the operations further comprise transmitting, by the first computing device and to the second computing device, at least one of the receipt image, the final cost, and the final quantity.

19. The computer-based system of claim 15, wherein the operations further comprise receiving, by the second computing device, a communication from the third computing device to set a time for delivery.

20. The computer-based system of claim 15, wherein the operations further comprise receiving, by the third computing device, a communication from the second computing device to assess availability of the executor of the second user profile authenticated on the third computing device.
